(19) United States
(12) Patent Application Publication
(10) Pub. No.: US 2004/0267968 A1
(43) Pub. Date: Dec. 30, 2004

(54) Implementation of a column interleaving function with a limited amount of columns

(75) Inventor: Peter Brandt, Herent (BE)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignees: Agilent Technologies Belgium S.A./N.V; Agilent Technologies, Inc.

(21) Appl. No.: 10/603,273

(22) Filed: Jun. 25, 2003

(51) Int. Cl. G06F 3/00

(52) U.S. Cl. 710/1

(57) ABSTRACT

The present invention is related to a method to implement a column interleaving function, comprising the steps of:

Providing a number of memories equal to the maximum number of columns in the interleaver function,

Inputting a stream of data entities,

Writing said data entities successively into a memory, until all memories are completely filled or until all data entities are written,

Performing selection and permutation on said memories,

Reading out said data entities in said permuted memories, in a memory-by-memory fashion.

### FIELD OF THE INVENTION

The present invention is related to an implementation of an interleaver, used in communication systems to protect the transmitted data.

### STATE OF THE ART

In communication systems interleaving is an often-used technique, mostly in conjunction with coding techniques, to protect data signals against burst errors.

In a column-interleaving function, data entities are written into rows and after column permutation, read from columns. For a bit interleaver, the data entity is a logical one or zero.

Interleaving functions require some kind of memory structure. The technical problem addressed by this invention is that of implementing said memory structure in a more efficient way.

### AIMS OF THE INVENTION

The present invention aims to provide an efficient memory structure required in the implementation of a column interleaving function that overcomes the disadvantages of the prior art solutions.

### SUMMARY OF THE INVENTION

The invention relates to a method to implement a column interleaving function, comprising the steps of:

Providing a number of memories equal to the maximum number of columns in the interleaver function,

Inputting a stream of data entities,

Writing said data entities successively into a memory, until all memories are completely filled or until all data entities are written,

Performing selection and permutation on said memories,

Reading out said data entities in said permuted memories, in a memory-by-memory fashion.

In an advantageous embodiment the data entities in the input stream are first written into a register and when the register is filled, the step of writing into a memory is applied.

In one embodiment of the invention the data entities are logical ones and zeros. In another embodiment the data entities are multiple bit words. In a specific embodiment the data entities are three bit words.

Preferably the register is arranged to store each multiple bit word at one location in said memories.

In a specific embodiment the number of columns used in the column interleaver function is changed on the fly, whereby the number of columns does not exceed the maximum number of columns.

As a second object the invention relates to a module for column interleaving, comprising means for applying a method as previously described.

In another preferred embodiment an integrated circuit device comprises such a module.

Typically a communication system device comprises a module or an integrated circuit device as described above.

In an advantageous embodiment a spread-spectrum communication apparatus comprises such a module or an integrated circuit device.

As another object the invention relates to a column interleaver, comprising a number of memories equal to the maximum number of columns desired in the interleaver and means to perform column selection and permutation. In a specific embodiment the column interleaver further comprises a register.

### SHORT DESCRIPTION OF THE DRAWINGS

FIG. 1 represents the concept of a column interleaving function.

FIG. 2 represents a prior art solution.

FIG. 3 represents a solution according to the invention.

FIG. 4 represents an embodiment of the invention with three bit words, still performing bit-based interleaving.

### DETAILED DESCRIPTION OF THE INVENTION

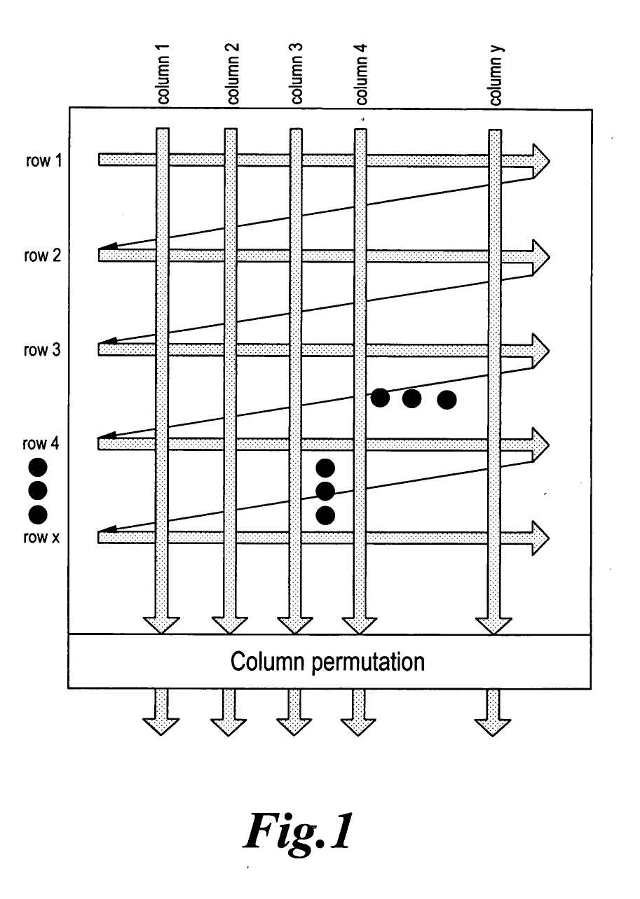

FIG. 1 shows the concept of a column interleaving function. Data entities are written into a memory on a row-by-row basis. After permuting the columns they are read from the columns. In a bit interleaver the data entities are bits, i.e. logical ones and zeros.

In some application areas, the amount of rows and columns are flexible, depending of the data block size. The invention described here can have a flexible amount of rows but requires a limited amount of columns.

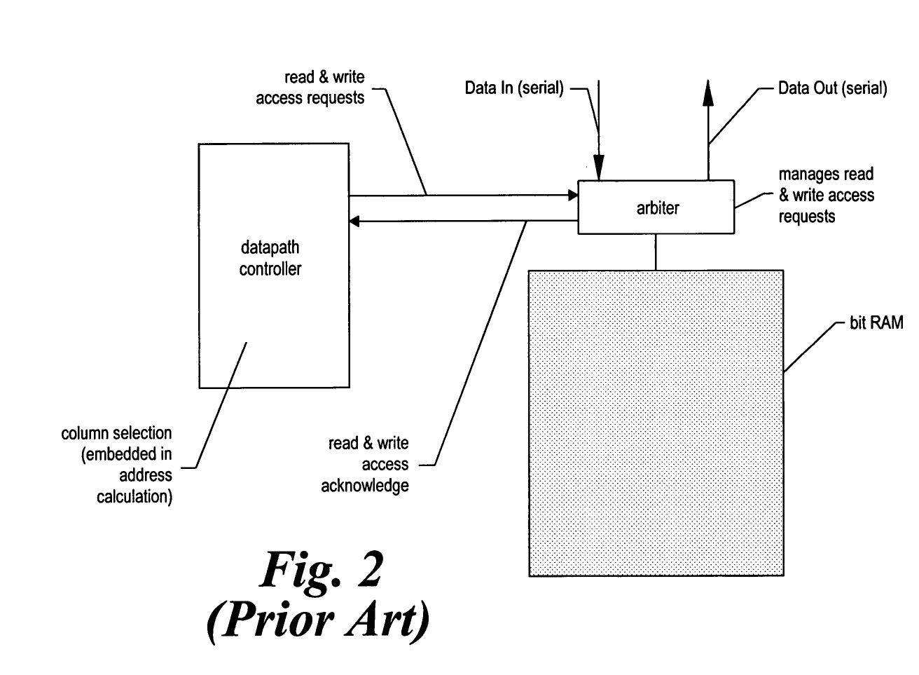

FIG. 2 shows the prior art solution. Serial data is written into a bit RAM on consecutive addresses. This writing represents the interleaver row-writing action. A bit RAM is used because column selection and permutation is bit-based. This column selection and permutation is implemented by the address calculation for reading out the data. With this solution there are several disadvantages like relatively high power consumption and memory requirements.

By using a smart memory structure and by grouping the input data before writing to memory, the interleaver implementation can be improved in several ways:

Less power consumption by reducing the amount of memory accesses and by using distributed memory,

Increased memory read-write bandwidth by removing the serial bottleneck and by changing the data entities from bits to multiple bit words,

Very straightforward address calculation.

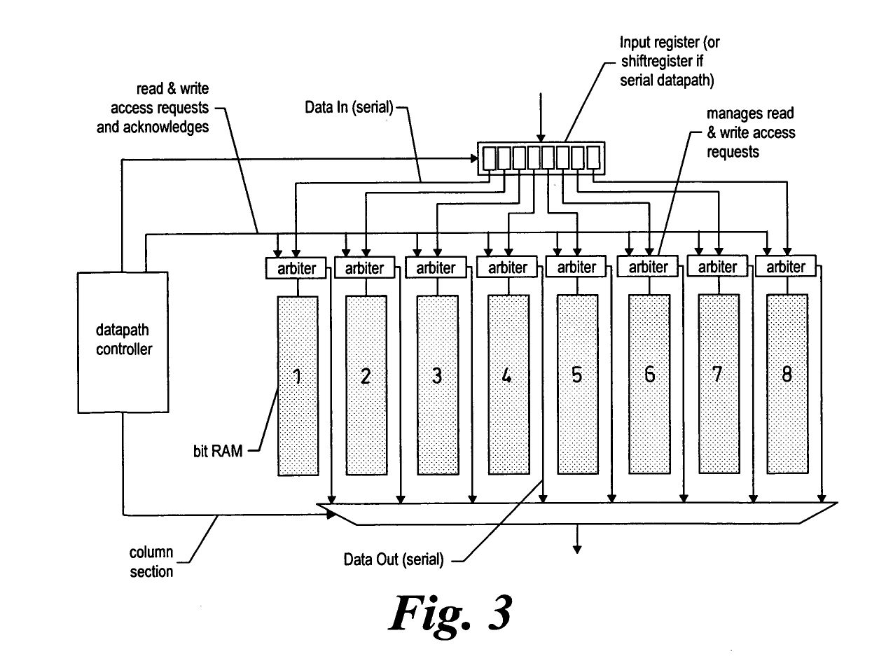

FIG. 3 discloses an implementation according to the invention. In case of a serial data input stream data is first written into a shift register. Also parallel data not having the right format (number of parallel streams) is first written into a shift register. The width of this register equals the amount of columns of the interleaver function. Thus, if the number of parallel data streams corresponds to the number of columns, no input register is required. Once the register is filled completely, each bit is written into a separate bit-oriented memory. There is one memory for every column defined in the interleaver function. When the column data is read out, the data is already sorted into columns. One only has to select the correct memory to perform the permutation function (done by multiplexer). While reading out the columns, there is only one memory active at the time.

As mentioned before, the input register is not really necessary for the interleaver function as such; it just synchronises the memory accesses and takes away possible data throughput bottlenecks. This latter feature is very important. If, for example, the data is coming from a turbo encoder (this is the case in 3GPP outer modem), the encoder output generates multiple bits every clock cycle. Due to the use of multiple memories, one can write more than one bit to memory in one clock cycle and avoid possible wait states in the encoder data path or avoid the need to clock the memories on a higher frequency to prevent these wait states.

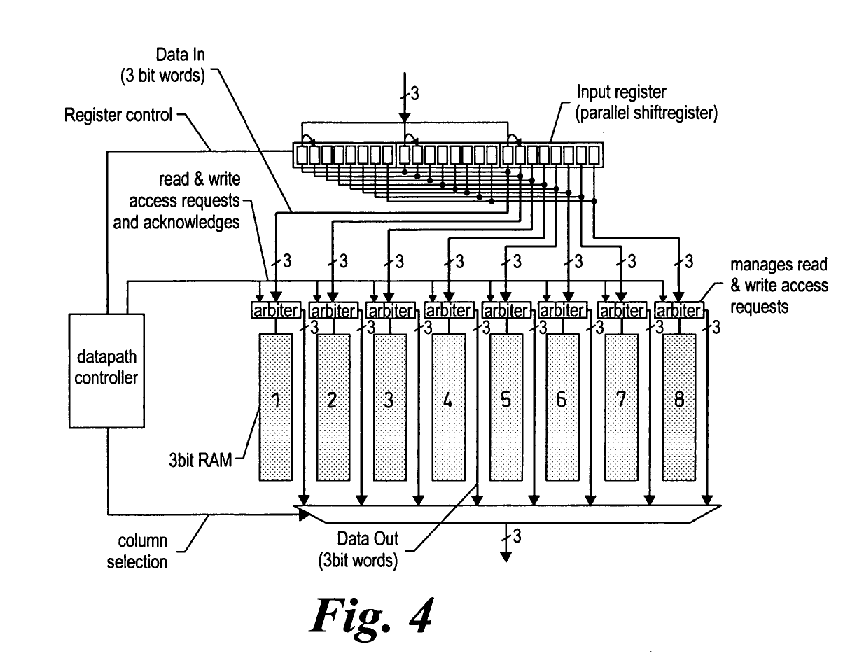

FIG. 4 discloses in a specific embodiment of the invention an extra enhancement of the input register. By adapting the input register, one can use multiple bit words in the memories (instead of using bit-oriented memories) and still perform a bit-oriented permutation. As a result, the amount of memory accesses can be limited in addition to the decrease achieved by using multiple memories. This decrease improves the power consumption and increases the read/write bandwidth of the memories (with same clock). In FIG. 4 a scheme employing three-bit words is shown. Schemes with other word lengths can be derived in a straightforward way.

1. Method to implement a column interleaving function, comprising the steps of:
Providing a number of memories equal to the maximum number of columns in the interleaver function,
Inputting a stream of data entities,
Writing said data entities successively into a memory, until all memories are completely filled or until all data entities are written,
Performing selection and permutation on said memories,
Reading out said data entities in said permuted memories, in a memory-by-memory fashion.

2. Method to implement a column interleaving function as in claim 1, wherein data entities in the input stream are first written into a register and when said register is filled, the step of writing into a memory is applied.

3. Method as in claim 1 or 2, wherein said data entities are logical ones and zeros.

4. Method as in claim 1 or 2, wherein said data entities are multiple bit words.

5. Method as in claim 1 or 2, wherein said data entities are three bit words.

6. Method as in claim 2, wherein said register is arranged to store each multiple bit word at one location in said memories.

7. Method as in any of the previous claims, wherein the number of columns used in the column interleaver function is changed on the fly, said number of columns not exceeding said maximum number of columns.

8. A module for column interleaving, comprising means for applying a method as in any of the previous claims.

9. An integrated circuit device, comprising a module as in claim 8.

10. A communication system device, comprising a module as in claim 8 or an integrated circuit device as in claim 9.

11. A spread-spectrum communication apparatus comprising a module as in claim 8 or an integrated circuit device as in claim 9.

12. A column interleaver, comprising a number of memories equal to the maximum number of columns desired in the interleaver and means to perform column selection and permutation.

13. The column interleaver as in claim 12, further comprising a register.
